(19) United States
(12) Patent Application Publication
(10) Pub. No.: US 2005/0216311 A1
(43) Pub. Date: Sep. 29, 2005

(54) Communications system and a method of processing medical data

(76) Inventors: Moritz Gmelin, Ettlingen (DE); Armin Bolz, Buckenhof (DE)

Correspondence Address: DILWORTH & BARRESE, LLP, 333 EARLE OVINGTON BLVD., UNIONDALE, NY, 11553, US

(21) Appl. No.: 10/977,964

(22) Filed: Oct. 29, 2004

(30) Foreign Application Priority Data
Oct. 29, 2003 (DE) 103 50 538.5

(51) Int. Cl. G06F 17/60

(52) U.S. Cl. 705/3

(57) ABSTRACT

The present invention relates to a communications system for the processing of medical data comprising a medical device which has recording means for the recording of medical data, a memory unit for the callable storing of the data and a communications interface for the data transfer; comprising a server which has a memory unit in which the data recorded by the medical device are stored in a callable manner and a communications interface by means of which the server is in communication with one or more clients at least at times; and comprising at least one client which has a memory unit, an evaluation unit and a communications interface, wherein the data recorded by the medical device are stored in the memory unit, wherein the evaluation unit includes an evaluation application for inspection, preparation, change or supplementation of the data stored in the memory unit of the client, wherein the data prepared, changed or supplemented in the client can be transmitted by means of the communications interface from the client to the server and wherein these data can be stored in the memory unit of the server. The invention further relates to a method for the processing of medical data.

The invention relates to a communications system and to a method of processing medical data. It is of great importance, in particular in the providing of first care and in the post-treatment of emergency patients, that the data obtained within the framework of the treatment can be reliably recorded and can be viewed in real time or close to real time by the treating physician and can be completed as required. To make the data recorded by medical devices available to a large circle of users for inspection, it has been proposed to store the data on a web server. Such a system is known from WO 02/17593 A2. The system disclosed therein permits the visualization of treatment data which are transmitted, for example, in a wireless manner from a heart pacemaker to a communications device and from this to a web server. The observation of a patient is thereby possible without the necessity of an attending physician. The data stored on the web server can be inspected by authorized users by means of an Internet browser.

The system known from WO 02/17593 A2 has the disadvantage that the treatment data and user programs are located on the central web server from where the required data have to be downloaded when required onto a local computer and can be visualized here by means of the browser. With such a browser application, all data or applications are downloaded from the central web server onto the local computer on every call, whereby comparatively large amounts of data to be transferred and correspondingly long transfer times result. A further disadvantage results from the fact that users without an Internet connection naturally do not have the possibility of inspecting the treatment data located on the web server in such a system. In the system known from WO 02/17593 A2, it is finally of disadvantage that the possibility generally also exists, thanks to the transfer of complete data records, of listening to these or calling them without authorization, which is naturally undesirable with sensitive patient and treatment data.

It is therefore the underlying object of the invention to provide a communications system and a method of processing medical data which works at low data transfer times and which is also accessible to users without an Internet connection.

This object is solved by a communications system having the features of claim 1 and by a method having the features of claim 27. Advantageous aspects of the invention form the subject of the dependent claims. The present communications system relates to a client/server architecture in which an evaluation application stored locally on the client can be called locally. It is possible by means of the evaluation application to visualize and to process locally stored data. Working with locally stored data reduces the risk that sensitive data can be heard, called or inspected without authorization. The data prepared, amended or supplemented on the client can be transferred to the server and can be saved there and are then available to other users. The client receives the medical data, for example, either directly from the medical device or from the server, provided that they are already present on the server to be called.

The term medical data is to be understood to include all data relevant within the framework of patient care or patient treatment such as treatment data which are obtained during medical treatment or also data which arise without the intervention of a physician such as the continuously recorded data of a heart pacemaker, of a blood sugar sensor, etc.

The presence of a local application on the client brings along the advantage that users without an Internet connection can also be served and that the loading of an application from a central server is dispensed with, whereby the amount of data to be transferred can be reduced. On the exchange of data between the server and the client for the purpose of synchronization, provision can furthermore be made in an advantageous aspect of the invention for the whole data record not to be transferred, but only the difference amount in the form of new or amended data, whereby the transfer times can be further reduced. It can be ensured on the basis of the possibility of transferring data from the client or clients to the server that the data record on the server is always updated.

The data transfer between the medical device, the client or clients and the server can take place in each case directly or indirectly by interposing further components of the system.

The data stored in the medical device can be transmitted directly to the client or clients or to the server via the medical device's communications interface.

The medical device can, for example, be an external defibrillator. Generally, the communications system in accordance with the invention and the method are also suitable for any other medical devices, preferably for transportable medical devices which are, for example, used in emergency deployments.

As stated above, in accordance with an advantageous aspect of the invention, means for the synchronization of the data of the server and of the client are provided by means of which only data prepared, amended or supplemented on the client can be transferred to the server. On a communication between the server and the client, all data of a data object are thus not transferred again, but only the difference amount. The same applies correspondingly to the changes made by further clients which are stored on the server. It also applies to such changes that, by means of the synchronization unit, only the changes or supplement made by the further clients are transferred from the server to the synchronizing client. It can thus be ensured that identical data records are present on all clients and on the server, with comparatively small amounts of data having to be transferred.

In a further aspect of the invention, provision is made for the evaluation application on the client to be a Java WebStart application. It is an advantage of this technology that the user can obtain updates of the software automatically via the Internet. In this process, the latest components of the software can be installed on start-up, provided there is an Internet connection. A further advantage of the Java WebStart application results from the fact that it is independent of platform and can accordingly be used independently of the operating system of the user.

In a further aspect of the invention, provision is made for at least one communications interface of the medical device and of at least one client to be an interface for the local transmission of data. The selection of the data transfer technology can be as desired. For example, infrared or Bluetooth can be considered. Provision can furthermore be made for a technology to be used which usually only serves remote data transfer such as mobile radio technology. There are absolutely no restrictions with respect to the technology of the data transfer between the medical device and the client. For the transfer of the data of the medical device, the latter can communicate with the client via an infrared interface or also, for example, by Bluetooth. The data can then, after possible preparation on the client, be transferred from the client to the server. The interface of the medical device can furthermore serve to take over data from the client such as location configuration data or device setting data. It is generally equally possible to transmit such data directly from the server to the medical device.

In a preferred aspect of the invention, a communications interface of the medical device is made as a mobile radio interface. The server or a communications server in this aspect of the invention likewise have a mobile radio interface by means of which data can be transferred from the medical device to the server or to the communications server and from there to the server. In this way, deployment or treatment data can be transferred directly from the medical device to the server. The transfer can take place by means of mobile radio technology or also by other suitable data transfer technologies. If the mobile radio technology is used, the GSM standard, GPRS or UMTS are used, for example.

The communications server can be a part of the server.

If the medical device and the server or a communications server have a mobile radio interface, provision can be made for data to be transferred from the server to the medical device or from the server to the communications server and from there to the medical device. It is possible in this manner to supply the medical device quickly with important data, for example with patient data, which are useful for the further treatment. It is moreover possible to provide the medical device with location data or configuration data via such a data link without it having to communicate with a client for this purpose.

Specific data for the location of the medical device, firmware updates, data relating to device settings of the medical device or patient data, in particular prior illnesses and data relating to current or past treatments can inter alia be stored in the memory unit of the server or of the client. These data or updates can be transferred by means of communication interfaces of the server, of the client and of the medical device directly from the server or from the client to the medical device or from the server to the client and by means of the communication interfaces of the client and of the medical device from the client to the medical device. In this way, the medical device can be configured by means of the client and/or by means of the server and can be supplied with relevant data, for example important and immediately required patient data.

In a further aspect of the invention, provision is made for the medical device to have means for the recording of measured values obtained in the course of a treatment. The means for the measured value recording can include detectors by means of which data transmitted by sensors by near transfer technology, e.g. by infrared or Bluetooth can be detected. It is particularly advantageous for the medical device to automatically detect sensors within range which transmit relevant data. The data of these sensors are, for example, stored in the memory of the medical device or of a defibrillator in addition to the ECG and are available on the reading out of the data. If the medical device is a defibrillator, the means for recording the measured data can include the electrodes of the defibrillator. The data processing on the defibrillator can relate, on the one hand, to the visualization of data, in particular to the presentation of the recorded ECG in real time. Parallel to this, the pulse frequency, and possibly the oxygen saturation, can be displayed on the monitor in numerical form. For this purpose, an external spO₂ sensor can be included in the data recording by Bluetooth. The data processing of the defibrillator can furthermore include the protocolling with respect to the parts of the protocol which have to be recorded close to real time. The data recording can be completed later with the help of the client 30.

Provision can furthermore be made for the medical device to have means for the recording of patient data. These can, for example, be reading means for any kind of memory media on which patient data are stored. One possibility is a chip card reading device for the reading out of an insurance card of the patient's. It is also conceivable that the means have input and/or output means by means of which data or a code can be input which have an association with the patient and permit the reading of the corresponding patient data into the medical device. Subsequently to the inputting of the data or of the code, provision can be made for the medical device to access the patient data from any memory. Provision can be made for the means to serve or the downloading of the patient data from an electrical patient file by the Internet. In this case, the means are made as apparatus for the download of the corresponding data from the Internet or also from any other non-web based server. It can be ensured by the means for the recording of patient data that basic information on the patient are available in the medical device. All information going beyond this can be input in the medical device or by means of the client.

In a further aspect of the invention, the medical device has means for the input and/or for the selection of data. This opens up the possibility of inputting data already during the deployment or the treatment which can be completed later to prepare a deployment protocol. If there are only limited input possibilities on the medical device, it is advantageous if only a selection of in pre-determined data takes place. The corresponding lists which contain the pre-determined selection responses can be stored in the location file of the server and be read into the medical device from there via the client.

If the medical device is difficult to see during the treatment, it is of advantage for it to have a communications interface by means of which measured values taken in the course of a treatment can be transferred to a monitor preferably in real time. This can, for example, be the presentation of an ECG. The transfer of the measured values can take place, for example by Bluetooth. Other transfer technologies are generally also conceivable. Alternatively or additionally, the medical device can have an integrated monitor for the visualization of recorded treatment data, which is in particular of advantage if no external monitor or transfer possibility to an external monitor is present.

In a further aspect of the invention, provision is made for the communications system to have a receiver unit with a communications interface for the reception of the data stored in a callable manner in the medical device by means of infrared or Bluetooth, for example. The receiver unit can, for example, be located in the emergency room of a clinic and serves to call up quickly the treatment data present in the medical device. The data transferred in this manner can then, for example, be further processed and/or presented in the Intranet of a clinic. Provision can furthermore be made for the receiver unit to have an interface for the exchange of data with the server so that the treatment data or supplementary data can be called up from the server, which results, however, in longer transfer times.

In a further aspect of the invention, provision is made for the server to have a plurality of data records of which at least one first data record includes patient data and at least one second data record includes data relating to the medical device, with the data stored in the second data record not having any association with a specific patient. Only data of a respective device are stored in the second data record. These data have no relation to a specific patient for data protection reasons.

Provision can furthermore be made for the server to include at least one third data record with specific data for a physician and at least one fourth data record with specific data for the location of the medical device. The specific data for a physician can, for example, be personal data of the physician, data of his deployments, personal settings of the medical device, etc. The data specific for the location of the fourth data record can, for example, be data with respect to the possible operator at the location, a list of the medical devices of the location, clinics, vehicles or medication at the location or deployments carried out with the medical devices of the location.

It is particularly advantageous for the server to have a communications interface by means of which data of documents transmitted by telefax can be read into the server. For example every file of the server can be provided with a fax ID which identifies incoming telefaxes on the server and then archives them as a new document in the corresponding file. It is furthermore possible for the server to have a communications interface by means of which data stored on the server can be transmitted by telefax. It is conceivable that the sender instructs the server to transmit a fax with relevant data to a defined receiver. It is likewise conceivable to automatically provide data, for example deployment protocols, to all clinics of a location. It is likewise possible for fax polling codes to be assigned which permit a direct calling of data, for example of data of the last deployment, from the server by fax polling.

In a further aspect of the invention, conditions or threshold values linked to the data stored therein are stored, with means being provided by means of which a report or communication can be generated on the occurrence of the conditions or on the reaching of the threshold value. It is, for example, conceivable for a physician to be advised by SMS or by e-mail when a threshold of a blood sugar value is exceeded. It is also conceivable for messages on the state of the medical device to be stored in the server which initiates the sending of a telefax to the responsible service officer.

The invention furthermore relates to a method for the processing of medical data in which data medical data are recorded, called up and stored in a medical device and are transmitted to a receiver, in which the data recorded by the medical device are stored in a callable manner on a server, in which the data recorded by the medical device are stored on at least one client in communication with the server at least at times and are viewed, prepared, amended or supplemented by means of an evaluation application located on the client and in which the prepared, amended or supplemented data are transferred from the client to the server and are stored on the server. Advantageous aspects of the method are the subject of the dependent claims.

Further details and advantages of the invention will be explained in more detail with reference to an embodiment shown in the drawings. There are shown:

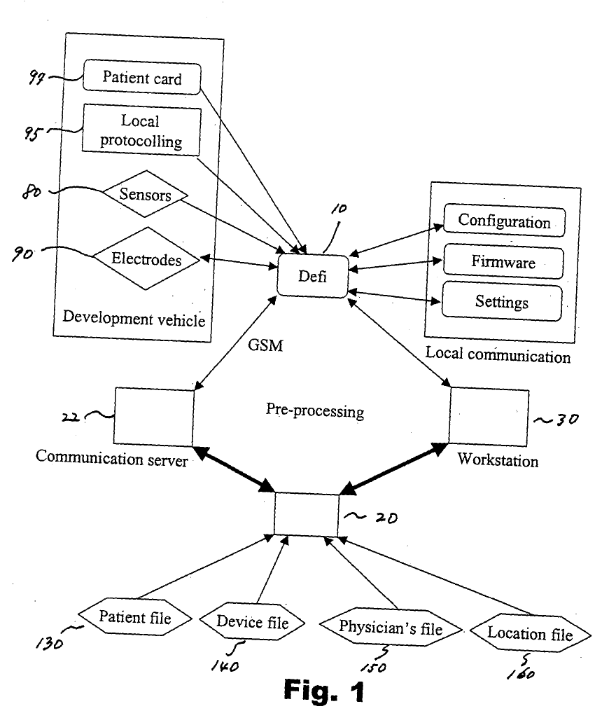

FIG. 1 a dataflow diagram of the communications system;

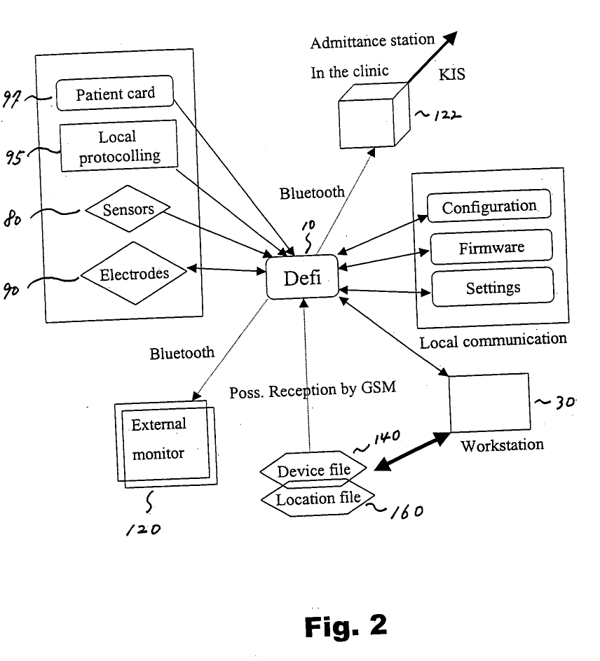

FIG. 2 a schematic overview of possible communication partners of a defibrillator;

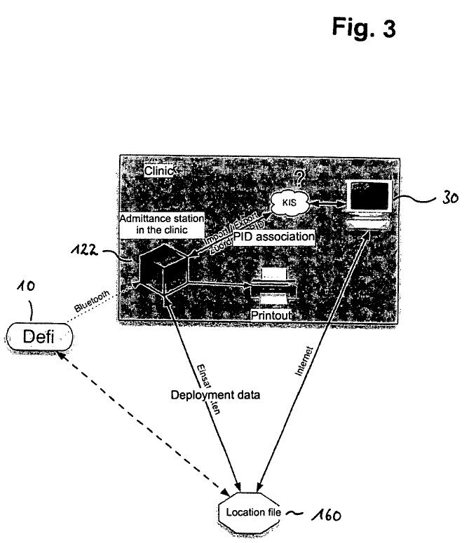

FIG. 3 a schematic representation of the inclusion of the defibrillator data into a clinic information system;

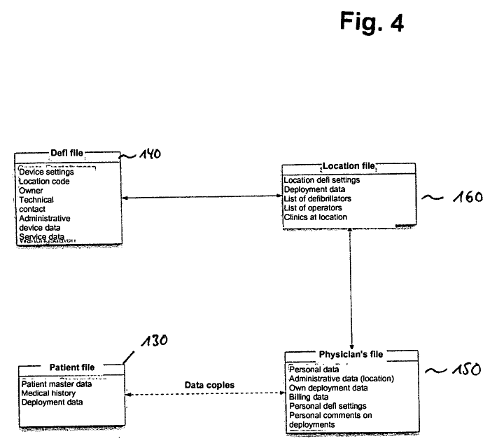

FIG. 4 a schematic representation of the files of the server and their relation to one another;

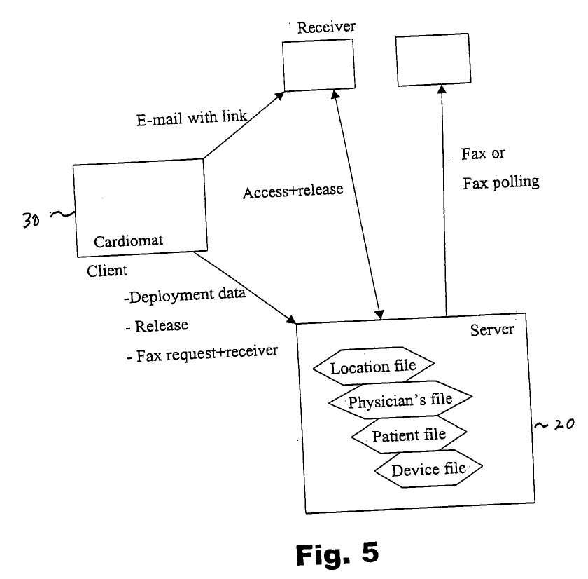

FIG. 5 a schematic representation of the forward sending of server data; and

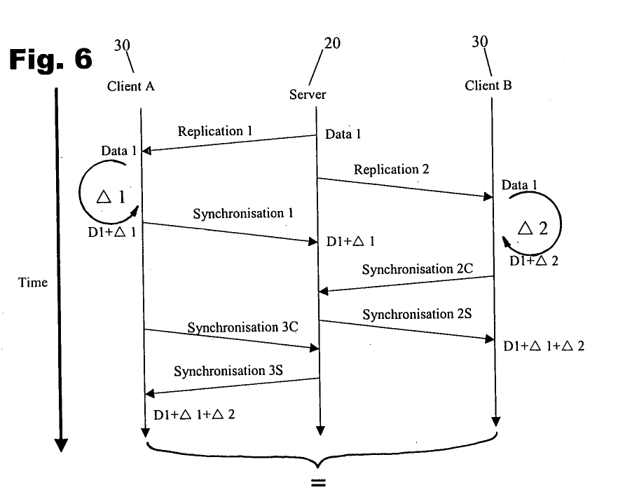

FIG. 6 a schematic representation of the synchronization technology of the communications system.

The principle is basic for the communications system in accordance with the invention that data of the medical device, for example of a defibrillator, do not have to be transmitted directly to a processing station, for example in the clinic, but are stored on a central server from where a fast distribution can take place to different receivers in different forms. The data can be collected from the server by means of the clients. This communication preferably takes place via an encoded HTTPS link. It is also generally conceivable to request the data of the server, for example the deployment data, by fax polling from the server. The calling or the transmitting of server data to a mobile terminal, for example a mobile phone or a PDA is also conceivable.

FIG. 1 shows the external defibrillator 10 which receives data from its electrodes 90, external sensors 80 in the near region, preferably by means of a wireless sensor system, and from a protocolling unit 95 of the defibrillator 10 via local inputs of the user. The defibrillator can furthermore be supplied with location configuration data, firmware updates and unit settings from a local client 30, preferably by infrared.

The location configuration data are loaded from the server 20, optionally processed on the client 30 and then transmitted to the defibrillator 10. It is likewise generally possible to transmit these data directly, for example by GSM, GPRS, UMTS, etc., from the server 20 to the defibrillator 10.

The same applies accordingly to device settings of the defibrillator 10 which are transmitted to the defibrillator 10 either via the client 30 or directly from the server 20. On the data transmission from the client 30, the possibility exists of the client 30 demanding the data from the server 20 or completing the data by synchronization with the server 20.

As can be seen from FIG. 1, communication with the server 20 takes place via the communications server 22.

As can furthermore be seen from FIG. 1, basic information on the patient can be read from the insurance card 97. All information going beyond this can be input on the defibrillator 10 or be detected subsequently by the client 30 during a re-processing, such as free text inputs. It is likewise generally conceivable and advantageous for patient data, for example prior treatment data, data on prior illnesses or the like, to be transmitted directly from the server 20 to the defibrillator 10 so that they are already available prior to, or at the latest during, the treatment.

The local protocolling 95 in accordance with FIG. 1 serves the possibility of inputting data during the deployment which can later be completed to form the deployment protocol. This relates above all to time-critical data such as the protocolling of the giving of shocks by the defibrillator, the dispensing of medication or the instigation of therapeutic measures. A large part of these measures and inputs are preferably stored for the whole location in the location file 160 of the server 20 so that the corresponding possible inputs only have to be selected from lists. The data detected by the sensors 80 or the electrodes 90 are read directly into the defibrillator 10. Unlike other detected data, all measured values have a constant scan frequency and can thus be stored in a space-saving manner in the form of an array. An intermediate saving of the individual channels in the memory of the defibrillator 10 takes place. When reading out the data by the client 30 or transmitting the data to the server 20, the individual channels can then be called up separately. An online streaming of the data can thus also take place on a PC or on an external monitor.

Continuous measured values are already packed in EDF form before transmission and are then transmitted in blocks. All detected channels are thus located in one transmission unit. The transfer has to take place in real time so that a connected monitor can reproduce the data live. On the subsequent reading out of the data, the real time transmission does not play any role. For this reason, the signal can here be sent in the full recorded quality. Provided that they are detected in the deployment, patient data are transmitted packed in the deployment data record. An association of patient data to a patient file 130 does not take place on the defibrillator 10, but only subsequently on the client 30 during the processing. While the patient data are taken over in the physician's file 150 of the server 20, they are not further taken over in the location file 160 for reasons of data protection.

To store the data, the defibrillator 10 communicates with the server 20 or with the communications server 22 or indirectly vie the client 30 which stores the data on the server 20, optionally after a processing or after supplementing. The contents are separated there and associated with the patient file 130 visible from FIG. 1, with the device file 140, the physician's file 150 and the location file 160.

It is likewise generally possible to carry out the communication by data streaming in which all signals present, including external signals received by Bluetooth, are output as an EDF stream via a serial link.

Every physician who works with the communications system receives his own physician's file 150 in which his personal data can be stored. Such data specific for the physician include: personal data of the physician, administrative data of the physician (location, specialist, etc.), data of his deployments, personal comments on his deployments, personal billing data on the deployments, personal defibrillator settings.

Every defibrillator 10 which is associated with a location receives access via the location file 160 to the common data of all defibrillators of a deployment location. It can thus be ensured that all defibrillators of a location access common pre-set data. Furthermore, the deployment data are stored in the location file 160, which brings along the advantage that a search for deployments is possible on a regional level without it needing to be known which defibrillator was used. Data specific for a location located in the location file 160 are: possible operators in order to make a list selection fast on the protocolling, list of the defibrillators at the location, clinics at the location with contact information, standardized medication repertoire of the location or of the ambulance, deployments carried out with the defibrillators of the location.

The following data are documented in the device file 140 containing data specific for the device: model, serial number, location, owner, contact partner, responsible technician, software version of all components, number of deployments, number of shocks given, next service, service protocols, link to the location file 160.

The patient data protocolled during the deployment are stored provisionally in the physician's file 150. From there, the physician can transfer the data into the patient file 130. What is recorded are: master data from the insurance card, time of emergency, DIVI (German Interdisciplinary Association of Intensive Care Medicine) protocol of the deployment, attending physician.

The deployment data are stored, as stated above, in the location file 160. In addition, a deployment protocol is stored which corresponds to the required standards. This protocol is partly recorded close to real time during the deployment, but can also be supplemented by the physician with the aid of the client 30 after the deployment. The stored deployment data serve the physician as the basis for the preparation of a billing form. The content of the deployment data record is: time of emergency, place of emergency, making of the emergency phone call, arrival of the defibrillator 10, measures instigated (medication, respiration, reanimation, shock application) with time stamp, measured values recorded (ECG, other sensors), patient data recorded (from the patient card), operator of the defibrillator, clinic of post-treatment, time of admission, other data as per DIVI protocol.

FIG. 4 shows the relationship of the named files, i.e. memory regions 130-160, to one another and their preferred contents. There are no direct links to the patient file 130 since this would not be permitted for reasons of data protection.

The possibility exists of attaching a digital signature to some of the data in the different files. This can also be realized by a signature of partial trees of the XML document stored on the server 20. Different persons or units can thus also sign partial amounts of data separately from one another. This is in particular relevant in the location file 160 in which different physicians make entries which must be indisputably associated with one person. In this process, the signature ensures the integrity and the non-disputability of the data. The signature is based on a private/public key signature on the basis of GnuPG. Whoever wants to sign data in the system must first have a code generated of which the public key is stored on a public key server. The private (secret) key remains the property of the owner and is additionally secured by a PIN. To sign data, a hash value is formed from the XML fragment to be signed and is signed with the private key. The signed hash value is attached to the XML document with the key ID of the code. The uniqueness of the signature ensures that the calculated signature can only be created with a single specific key from the hash value of the data. A different signature would have been created with any other key. To check the signature, the public key with the given key ID is called up from the key server and the inverse algorithm of the signature is applied to the data. In this process, the same value must be created as with the signature. If these values are not identical, the signed data have been changed and the signature is invalid.

In a preferred further development of the invention, an encoding of data takes place. It is provided in this process that the encoding preferably takes place at two points: on the communications path to prevent the interception of the data and on the filing on the server 20. The encoding on the communications path is taken over by the HTTPS protocol which is based on an asymmetric SSL encoding. The encoding for the filing in the database is a symmetrical one which only represents an additional securing of the server infrastructure. An encoding of the data for special recipients, such as would take place with an encoded e-mail communication, does not take place. This is not necessary since an examination of the access rights already takes place on the server 20. An encoding of the data for a specific recipient can be relevant if deployment data should be transmitted to a recipient by e-mail.

The control of the defibrillator 10 and the administration of a plurality of medical devices as well as the medical processing of the data is possible by means of the client 30. The client 30 has an application in the form of a Java WebStart application which makes the application independent of the operating system of the user.

Most medical data occurring are packed in the form of an XML document. The data can be processed and visualized both by the client software and by the server 20 in this form. However, the EDF format is better suited to the recorded measurement series since much lower overheads are incurred when it is used than when XML is used. The connection between XML and EDF data is achieved from the XML document via a linking of the EDF document.

The communications server 22 in accordance with FIG. 1 serves to permit the transfer of data from the defibrillator 10 to the server 20 or in the reverse direction. The server 22 receives the same data packages as the client 30 receives by infrared. The deployment protocol is generated from this in XML form and, separately therefrom, the EDF file with the measured values. Both are immediately transferred to the server 20. The server 22 can be realized directly on the server 20. The transfer of the data takes place, for example, by V.110 interface via the GSM network and thus digitally.

FIG. 2 shows in a further schematic representation the communications partner of the defibrillator 10. In addition to the communications partners already shown in FIG. 1, the external monitor(s) 120 is (are) provided in FIG. 2 which receive measured values in real time by Bluetooth.

Furthermore, an admittance station of a clinic is schematically shown in FIG. 2. It has a receiver unit 122 which has a communications interface for the reception of the data stored in the defibrillator 10 by means of Bluetooth.

FIG. 3 shows schematically how the deployment data can be made available to the clinic for post-treatment. In addition to the direct reception of the data from the defibrillator 10, the possibility exists of accessing the deployment data of the location file 160 of the server 20 via an Internet connection. Alternatively to this, deployment data can be taken directly from the location file 160 by the receiver unit 122, as can be seen from FIG. 3. This, however, requires the data from the defibrillator 10 to be transmitted to the server 20 and to its location file 160 in good time.

Furthermore, the possibility visible in FIG. 3 exists of transmitting the data records from the receiver unit 122 to the server 20 with the amendments made in the clinic.

A further possibility consists of visualizing and processing the data record in the clinic via the client 30. The data of the server can be transmitted in a wireless manner to the ambulance service, which is in particular of advantage with respect to the deployment data of prior deployments. It is generally also possible to replicate the data on the client 30 before the start of the journey and then to review them during the journey to the emergency deployment location.

The following functionalities are implemented in the receiver unit 122: reception of deployment data including patient information from the defibrillator 10 by means of Bluetooth; reception of data from the location file 160; immediate printout of the deployment protocol; browser-based administration of the previously received and current deployments. The following functionalities should be implemented in this process: taking over deployment data in the internal KIS (hospital information system) documentation; allocating deployment data to an existing patient file; opening a new patient file on the basis of the incident; taking over of the KIS documentation into the patient file.

Data processing takes place on the defibrillator 10, the client 30, the server 20 and also in the receiver unit 122. The data recorded on the defibrillator 10 are again verified on the client 30 and added to the complete DIVI protocol. In the client 30, the detected ECG data are again evaluated and classified by corresponding algorithms to the extent that this was not already done in detail on the defibrillator 10. The classification calculated can subsequently be filed directly in the ECG. The ECG representation on the client 30 allows a fast diagnosis within the data record. Conspicuous positions can be selected by mouse movements, zoomed and measured. A note can be inserted in the data development, which is then filed in the deployment data, by simply double-clicking in the ECG at the corresponding position.

The ECG can also be reproduced in real time, synchronously to the recorded audio data, in this representation. The main task of the client 30 in the physician's version will be to complete the deployment protocol. The data recorded by the local protocolling are subjected to post-processing and supplemented. Text inputs are possible ergonomically.

The client 30 furthermore permits the preparation of a deployment billing in the form of a bill.

If patient information has not been able to be read in from the patient card during the deployment, they can be added later by means of the client 30. It must in particular be taken into account that the possibility should exist to associate the deployment data with an existing patient file 130 or to generate a new patient file 130 which is then filled with the deployment data.

FIG. 5 shows the further transmission of the data stored on the server 20. The further transmission permits a fast forwarding of recorded deployment data to specific receivers. The following mechanisms are available:
e-mail with link: the sender releases access to the data record in the location file 160 and sends the receiver a link which displays this data record directly in the browser;
fax forwarding: the sender instructs the server 20 to send a fax with the deployment protocol to a defined receiver. Deployment protocols can also be sent automatically to all clinics in the location region.
fax polling: 160 fax polling codes can be assigned with one location file which permit a direct polling of the last deployment from the server by fax polling;
synchronization: if a receiver likewise has a client 30, access to new deployments can take place by a simple synchronization as will be explained in more detail below.

It is furthermore possible to provide the client 30 with external data sources. It is also possible to perform statistical evaluations on the deployments carried out on the client 30, which is in particular important for quality assurance.

Possible receivers of data stored on the server 20 are the clinic, the ambulance service, the family doctor and a rehabilitation institute, the ambulance service for the purpose of quality assurance and the patient.

A simple solution with respect to the communication with the clinic consists of transferring the data from the server 20 to the clinic by telefax. For this purpose, the defibrillator 10 must be read out and the deployment data must be transferred to the server 20, which brings along a delay. The reception of the data in the clinic via the receiver unit 22, for example by Bluetooth in accordance with FIG. 3, is more advantageous with respect to the speed. The receiver unit 122 receives the deployment data record as it was protocolled during the deployment. The data can be called up or printed from the receiver unit 122. The data can subsequently be presented on the screen or, under certain circumstances, be imported directly into the clinic information system.

Latency between the accident deployment and the availability of the data play a subordinate role with respect to the family doctor and the rehabilitation institutes. The data access can take place, on the one hand, via the client 30 or also via an Internet view or also be requested from the server by fax polling.

Real time access to the data is not required for the patient and equally not for the family doctor or the rehabilitation institute. It is sufficient here for the patient, who receives copies of the data from the family doctor, from the clinic or from the ambulance service in his patient file 130, to have access to the data after the treatment. This access can take place by web browser since no processing functionality is necessary.

FIG. 6 shows the routine of the synchronization of server data and client data. As can be seen from FIG. 6, parts of the XML data object of the server 20 are replicated (replication 1, 2) and stored locally on the clients 30 (client A, client B). Changes on the clients (Δ1, Δ2) are protocolled and carried out on the server 20 in the synchronization process (synchronization 1, 2C). Changes synchronized in the meantime on the server by other clients are in turn passed on to the synchronizing client (synchronization 2S, 3S) after a corresponding examination (synchronization 2C, 3C). The synchronization includes the following steps in detail: protocolling of the changes according to Xpath, time and type of the change on the client; transfer of the changes to the server; checking of the changes protocolled on the server since the last synchronization of the client; resolution of conflicts of the synchronization; filing of the changes in a table on the server; transfer of the remaining changes to the clients; if binary elements are changed or added on the client, these changed objects are requested by the client; filing of the binary objects in the database.

Objects which are newly filed on the client and which can occur multiple times in a collection are provided with temporary (negative) IDs on the client. During the synchronization, a check is then made on the server as to which IDs have already been allocated for this path. The server then changes the negative IDs to the next higher IDs not yet allocated. This change is then reported to the client so that this can update its local copy. In this manner, different clients can add new elements simultaneously without mutually influencing one another.

It can be of importance that, when data threshold values are reached or exceeded, actions can be triggered. For this purpose, so-called watch points are preferably set which transmit a message, for example an SMS, on the exceeding of a threshold value. The following steps are to be carried out in this process: defining of the data element to be watched; defining of the criteria to be watched; defining of the action to be triggered (sending a message, etc.); filing of the watch point in the database; working through all watch points of a file on every synchronization; time-controlled working through of all watch points of all files.

To ensure secure data administration, it can be of advantage to grant different users releases to different parts of the data record of the server 20. It can be laid down here which user has read and write access to which partial tree of the XML data object. Furthermore, a user can pass on the administration rights to his own data record to other users who then take over the rights management of the owner quasi as deputies. The paths in the XML tree are hidden behind text descriptions for the user. The following steps must be carried out in this process: selection or opening of a co-user of the user's own data record; defining of the read/write rights in the data record; possibly, definition of the co-user as an administrator on the user's own data record who can then in turn open further co-users (and also co-administrators).

The possibility exists in this process of not only being able to grant rights to individual elements of the data, but to whole thematic complexes which can be located at different locations of the data object of the server.

1. A communications system for the processing of medical data
comprising a medical device which has recording means for the recording of medical data, a memory unit for the callable storing of the data and a communications interface for the data transfer;
comprising a server (20) which has a memory unit in which the data recorded by the medical device as stored in a callable manner and a communications interface by means of which the server (20) is in communication with one or more clients (30) at least at the times;
and comprising at least one client (30) which has a memory unit, an evaluation unit and a communications interface, wherein the data recorded by the medical device are stored in the memory unit, wherein the evaluation unit includes an evaluation application for inspection, preparation, change or supplementation of the data stored in the memory unit of the client (30), wherein the data prepared, changed or supplemented in the client (30) can be transmitted by means of the communications interface from the client (30) to the server (20) and wherein these data can be stored in the memory unit of the server (20).

2. A communications system in accordance with claim 1, wherein the data stored in the medical device can be transmitted via its communications interface directly to the client or clients (30) or to the server (20).

3. A communications system in accordance with claim 1, wherein the medical device is an external defibrillator (10).

4. A communications system in accordance with claim 1, wherein means for the synchronization of data of the server (20) and of the client (30) are provided by means of which only data prepared, changed or supplemented in the client (30) can be transmitted to the server (20).

5. A communications system in accordance with claim 4, wherein the preparations, changes or supplementing of data carried out by further clients and stored on the server (20) can be transferred from the server (20) to the client (30).

6. A communications system in accordance with claim 1, wherein the evaluation application on the client (30) is a Java WebStart application.

7. A communications system in accordance with claim 1, wherein at least one communications interface of the medical device and of at least one client (30) is an interface for data transfer in the near region.

8. A communications system in accordance with claim 1, wherein a communications interface of the medical device is made as a mobile radio interface and wherein the server (20) or a communications server (22) in communication with it likewise have a mobile radio interface by means of which data can be transferred from the medical device to the server (20) or to the communications server (22) and from this to the server (20).

9. A communications system in accordance with claim 8, wherein the communications server (22) is a component of the server (20).

10. A communications system in accordance with claim 1, wherein a communications interface of the medical device is made as a mobile radio interface and wherein the server (20) or a communications server (22) in communication with it likewise has a mobile radio interface by means of which data can be transferred from the server (20) to the medical device or from the server (20) to the communications server (221 and from this to the medical device.

11. A communications system in accordance with claim 1, wherein data specific for the location of the medical device, firmware updates, data relating to device settings of the medical device or patient data, in particular prior illnesses, data relating to current or past treatments are stored in the memory unit of the server (20) or of the client (30) and wherein these data or updates can be transferred directly from the server (20) or from the client (30) to the medical device or from the server (20) to the client (30) by the communications interface of the server (20), the client (30) and of the medial device and from the client (30) to the medical device by the communications interfaces of the client (30) and of the medical device.

12. A communications system in accordance with claim 1, wherein the medical device has means for the recording of measured values-obtained in the course of a treatment.

13. A communications system in accordance with claim 12, wherein the means for the recording of the measured values include detectors by means of which data transferred from the sensors (80) by infrared or Bluetooth can be recorded.

14. A communications system in accordance with claim 3, wherein the means for the recording of the measured values include the electrodes (90) of the defibrillator (10).

15. A communications system in accordance with claim 1, wherein the medical device has means for the recording of patient data.

16. A communications system in accordance with claim 1, wherein the medical device has means (95) for the inputting and/or for the selection of data.

17. A communications system in accordance with claim 1, wherein the medical device has a communications interface by means of which measured values obtained in the course of a treatment can be transferred to a monitor (120) in real time.

18. A communications system in accordance with claim 17, wherein the measured values can be transferred via a communications interface of the medical device by means of Bluetooth.

19. A communications system in accordance with claim 1, wherein the communications system has a receiver unit (122) with a communications interface for the reception of the data stored in a callable manner in the medical device by means of infrared or Bluetooth.

20. A communications system in accordance with claim 19, wherein the receiver unit (122) furthermore has an interface for the exchange of data with the server (20).

21. A communications system in accordance with claim 1, wherein the medical device has an integrated monitor for the visualization of recorded treatment data.

22. A communications system in accordance with claim 1, wherein the server (20) has a plurality of data records of which at least one data record (130) includes patient data and at least one second data record (140) includes data relating to the medical device, wherein the data stored in the second data record (140) have no association with a specific patient.

23. A communications system in accordance with claim 22, wherein the server (20) includes at least one third data record (150) with data specific for a physician and at least one fourth data record (160) with data specific for the location of the medical device.

24. A communications system in accordance with claim 1, wherein the server (20) has a communications interface by which data of documents transmitted by telefax can be read into the server (20).

25. A communications system in accordance with claim 1, wherein the server (20) has a communications interface by which data stored on the server (20) can be transmitted by telefax.

26. A communications system in accordance with claim 1, wherein there are stored in the memory unit of the server (10) conditions or threshold values linked to the data filed therein and wherein means are provided by means of which a message or communication can be generated on the occurrence of the condition or on the reaching of the threshold value.

27. A method for the processing of medical data in which medical data are recorded and stored in a callable manner in a medical device and are transferred to a receiver, in which the data recorded by the medical device are stored in a callable manner on a server (20), in which the data recorded by the medical device are stored on at least one client (30) in communication with the server (20) at least at times and are inspected, prepared, changed or supplemented by means of an evaluation application located on the client (30) and in which the prepared, changed or supplemented data are transferred from the client (30) to the server (20) and are stored on the server (20).

28. A method in accordance with claim 27, wherein the data stored in the medical device are transferred directly from the medical device to the server (20) or the client (30).

29. A method in accordance with claim 27, wherein the medical device is an external defibrillator (10).

30. A method in accordance with claims 27, wherein only data prepared, changed or supplemented in the client (30) are transferred to the server (20) for the purpose of the synchronization of data.

31. A method in accordance with claim 30, wherein the preparations, changes or supplementation carried out by further clients and stored on the server are transferred from the server (20) to the client (30).

32. A method in accordance with claim 27, wherein the data transfer between the medical device and the client (30) takes place by infrared data transfer.

33. A method in accordance with claim 27, wherein data are transferred from the medical device to the server (20) or to a communications server (22) in communication with it or from the server (20) or from the communications server (22) to the medical device by means of mobile radio technology.

34. A method in accordance with claim 33, wherein the data transferred are the patient data.

35. A method in accordance with claim 27, wherein measured values obtained in the course of the treatment are detected and recorded by the medical device.

36. A method in accordance with claim 29, wherein the data detection takes pace by means of the electrodes (90) of the defibrillator (10) or by means of detectors which receive the data by infrared data transfer or by Bluetooth data transfer.

37. A method in accordance with claim 27, wherein a receiver unit (122) is provided and wherein the data stored in the medical device are transferred to the receiver unit (122) by infrared or by Bluetooth.

38. A method in accordance with claim 37, wherein data are transmitted from the server (20) to the receiver unit (122) and/or from the receiver unit (122) to the server (20).

39. A method in accordance with claim 27, wherein the server (20) can be addressed by a telefax number and wherein the data content of the telefax is read into the server (20).

40. A method in accordance with claim 27, wherein data stored on the server (20) are sent by telefax on the demand of the receiver or of a third-party.
